(19) United States
(12) Patent Application Publication
(10) Pub. No.: US 2014/0348719 A1
(43) Pub. Date: Nov. 27, 2014

(54) PHARMACEUTICAL COMPOUND STABILIZING FILTER COMPOSITIONS AND METHODS OF MAKING AND USING SAME

(71) Applicant: BUREAU VERITAS, FT. LAUDERDALE, FL (US)

(72) Inventors: Michael Anthony Rodriguez, Roselle, IL (US); Chad Herman, Redding, CT (US)

(21) Appl. No.: 14/183,952

(22) Filed: Feb. 19, 2014

Related U.S. Application Data
(60) Provisional application No. 61/782,638, filed on Mar. 14, 2013.

(51) Int. Cl. B01J 16/00; C09K 15/30

(52) U.S. Cl. CPC B01J 16/00; C09K 15/30
USPC 422/222; 252/401; 427/244

(57) ABSTRACT

In one aspect, the invention relates to filter apparatuses useful as sampling media and stabilizing pharmaceutical compounds, methods of making same, compositions useful for stabilizing pharmaceutical compounds, and methods of isolating pharmaceutical compounds from an air stream using the apparatuses and compositions. This abstract is intended to be used as a scanning tool for purposes of searching in the particular art and is not intended to be limiting of the present invention.

### CROSS-REFERENCE TO RELATED APPLICATIONS

This application claims the benefit of U.S. Provisional Application No. 61/782,638 filed on Mar. 14, 2013, which is incorporated herein by reference in its entirety.

### BACKGROUND

Currently, potent active pharmaceutical ingredients (API) are regularly being developed and manufactured by pharmaceutical companies. Throughout most phases of the manufacturing process, API is generally processed as a powder, including during weighing, transferring, mixing, blending, granulation, and pressing. Consequently, during each phase there is a certain amount of API that becomes airborne. Not only does this aerosolized API present a hazard to the pharmaceutical worker, but undetected, it can contribute to API product loss.

For the worker, physical exposure to API can occur as enteral ingestion through mouth and nose entry, transdermal absorption, mucosal absorption, and even ocular absorption. Toxicological effects of API exposure will depend on the API, but effects can range from localized superficial irritation to organ damage to carcinogenic toxicities.

Accordingly, pharmaceutical manufacturers employ containment equipment during the different manufacturing phases, starting from API production to formulation of the final product. The containment devices, which can include isolators, transfer systems, and other contained process equipment, exist to help minimize discharge of API particles into environment. To verify performance of containment equipment, air samples are regularly taken to determine the airborne particulate concentration. Generally, air sampling involves the use of a mechanical device in combination with media to collect particulates from the air. After a minimum air volume has been collected, the media is sent to the laboratory for analytical analysis.

Unfortunately, however, due to components in the environment, certain pharmaceutical compounds become oxidized during the collection period. This pharmaceutical degradation, in combination with the limits of detection, constrains true detection of APIs at very low levels. For highly potent APIs, the inability to detect airborne API at sufficiently low levels can create serious exposure hazards for the worker during occupational activities. Due to growing prevalence of potent API manufacturing, there exist a need to develop new methods and devices for stabilizing aerosolized pharmaceuticals to allow detection at low airborne concentrations, including the development of compounds and compositions capable of stabilizing pharmaceuticals on sampling media. This need and other needs are met by various aspects of the present disclosure.

### SUMMARY

In accordance with the purpose(s) of the invention, as embodied and broadly described herein, the invention, in one aspect, relates to filter apparatuses useful as sampling media, stabilizing pharmaceutical compounds, methods of making same, compositions useful for stabilizing pharmaceutical compounds, and methods of isolating pharmaceutical compounds from an air stream using the apparatuses and compositions.

Disclosed herein are filtration apparatuses comprising: (a) a composition of an ionic liquid iodide and an antioxidant selected from ascorbic acid (Vitamin C), adipic acid, butylated hydroxyanisole (BHA), butylated hydroxytoluene (BHT), citric acid, fumaric acid, glutamic acid, malic acid, propyl gallate, sulfurous acid, tartaric acid, tocopherol (Vitamin E), thiols, and derivatives and salts thereof; and (b) a hydrophilic filter membrane.

Also disclosed herein is a method of making filtration apparatus, the method comprising the steps of: (a) mixing a low boiling solvent, an ionic liquid iodide, and an antioxidant; (b) applying the mixture to a hydrophilic filter membrane; and (c) forming a gel from the mixture on the membrane by removing at least a portion of the solvent.

Also disclosed herein are methods for making a filtration apparatus, the method comprising the steps of: (a) mixing a low boiling solvent, an ionic liquid iodide, and an antioxidant selected from ascorbic acid (Vitamin C), adipic acid, butylated hydroxyanisole (BHA), butylated hydroxytoluene (BHT), citric acid, fumaric acid, glutamic acid, malic acid, propyl gallate, sulfurous acid, tartaric acid, tocopherol (Vitamin E), thiols, and derivatives and salts thereof; (b) applying the mixture to a hydrophilic filter membrane; and (c) forming a gel from the mixture on the membrane by removing at least a portion of the solvent.

Also disclosed herein are methods of isolating pharmaceutical compounds from an air stream, the method comprising the steps of: (a) providing a disclosed apparatus or a product produced by a disclosed process; and (b) exposing the apparatus or product to the air stream for a period of time sufficient to capture at least a portion of the pharmaceutical compounds.

Also disclosed are methods of isolating pharmaceutical compounds from an air stream, the method comprising the steps of: (a) providing a disclosed apparatus or a product produced by a disclosed process; (b) exposing the apparatus or product to the air stream for a period of time sufficient to capture at least a portion of the pharmaceutical compounds; (c) extracting the captured pharmaceutical compounds from the apparatus or product; and (d) detecting the extracted pharmaceutical compounds.

Also disclosed herein are compositions comprising a gel formed from methyl propylimidazolium iodide (MPII) and an antioxidant selected from ascorbic acid (Vitamin C), adipic acid, butylated hydroxyanisole (BHA), butylated hydroxytoluene (BHT), citric acid, fumaric acid, glutamic acid, malic acid, propyl gallate, sulfurous acid, tartaric acid, tocopherol (Vitamin E), thiols, and derivatives and salts thereof.

Also disclosed are uses of a disclosed apparatus, or composition.

Also disclosed are kits and systems using a disclosed apparatus, or composition.

While aspects of the present invention can be described and claimed in a particular statutory class, such as the system statutory class, this is for convenience only and one of skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

### BRIEF DESCRIPTION OF THE FIGURES

The accompanying figures, which are incorporated in and constitute a part of this specification, illustrate several embodiments and together with the description serve to explain the principles of the invention.

FIG. 1 shows an exploded view of a filter holder containing a filter membrane for capturing aerosolized pharmaceutical compounds in accordance with the present invention.

FIG. 2 shows a sampling cassette containing a filter membrane for use in capturing aerosolized pharmaceutical compounds in accordance with the present invention.

FIG. 3 shows a schematic diagram of a system for air sample collection and monitoring in accordance with the present invention.

Additional advantages of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DETAILED DESCRIPTION

The present invention can be understood more readily by reference to the following detailed description of the invention and the Examples included therein.

Before the present compounds, compositions, articles, systems, devices, and/or methods are disclosed and described, it is to be understood that they are not limited to specific synthetic methods unless otherwise specified, or to particular reagents unless otherwise specified, as such may, of course, vary. It is also to be understood that the terminology used herein is for the purpose of describing particular aspects only and is not intended to be limiting. Although any methods and materials similar or equivalent to those described herein can be used in the practice or testing of the present invention, example methods and materials are now described.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which can require independent confirmation.

### A. DEFINITIONS

As used herein, nomenclature for compounds, including organic compounds, can be given using common names, IUPAC, IUBMB, or CAS recommendations for nomenclature. When one or more stereochemical features are present, Cahn-Ingold-Prelog rules for stereochemistry can be employed to designate stereochemical priority, E/Z specification, and the like. One of skill in the art can readily ascertain the structure of a compound. If given a name, either by systemic reduction of the compound structure using naming conventions, or by commercially available software, such as CHEMDRAW™ (Cambridgesoft Corporation, U.S.A.).

As used in the specification and the appended claims, the singular forms “a,” “an” and “the” include plural referents unless the context clearly dictates otherwise. Thus, for example, reference to “a functional group,” “an alkyl,” or “a residue” includes mixtures of two or more such functional groups, alkyls, or residues, and the like.

Ranges can be expressed herein as from “about” one particular value, and/or to “about” another particular value. When such a range is expressed, a further aspect includes from the one particular value and/or to the other particular value. Similarly, when values are expressed as approximations, by use of the antecedent “about,” it will be understood that the particular value forms a further aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

References in the specification and concluding claims to parts by weight of a particular element or component in a composition denotes the weight relationship between the element or component and any other elements or components in the composition or article for which a part by weight is expressed. Thus, in a compound containing 2 parts by weight of component X and 5 parts by weight component Y, X and Y are present at a weight ratio of 2:5, and are present in such ratio regardless of whether additional components are contained in the compound.

A weight percent (wt. %) of a component, unless specifically stated to the contrary, is based on the total weight of the formulation or composition in which the component is included.

As used herein, the terms “optional” or “optionally” means that the subsequently described event or circumstance can or cannot occur, and that the description includes instances where said event or circumstance occurs and instances where it does not.

As used herein, the term “substituted” is contemplated to include all permissible substituents of organic compounds. In a broad aspect, the permissible substituents include acyclic and cyclic, branched and unbranched, carbocyclic and heterocyclic, aromatic and nonaromatic substituents of organic compounds. Illustrative substituents include, for example, those described hereinbelow. The permissible substituents can be one or more and the same or different for appropriate organic compounds. For purposes of this disclosure, the heteroatoms such as nitrogen can have hydrogen substituents and/or any permissible substituents of organic compounds described herein which satisfy the valencies of the heteroatoms. This disclosure is not intended to be limited in any manner by the permissible substituents of organic compounds. Also, the terms “substitution” or “substituted with” include the implicit proviso that such substitution is in accordance with permitted valence of the substituted atom and the substituent, and that the substitution results in a stable compound, e.g., a compound that does not spontaneously undergo transformation such as by rearrangement, cyclization, elimination, etc.

The term “organic residue” defines a carbon containing residue, i.e., a residue comprising at least one carbon atom, and includes but is not limited to the carbon-containing groups, residues, or radicals defined hereinabove. Organic residues can contain various heteroatoms, or be bonded to another molecule through a heteroatom, including oxygen, nitrogen, sulfur, phosphorus, or the like. Examples of organic residues include but are not limited to alkyl, substituted alkyl, cycloalkyl, substituted cycloalkyl, mono-substituted amino, di-substituted amino, acyloxy, cyano, carboxy, carboalkoxy, alkylcarboxamide, substituted alkylcarboxamide, dialkylcarboxamide, substituted dialkylcarboxamide, alkylsulfonyl, alkylsulfinyl, thioalkyl, thiohaloalkyl, alkoxy, substituted alkoxy, haloalkyl, haloalkoxy, aryl, substituted aryl, heteroaryl, heterocyclic, or substituted heterocyclic residues, wherein the terms are defined elsewhere herein. Organic residues can preferably comprise 1 to 36 carbons, 1 to 26 carbons, 1 to 18 carbon atoms, 1 to 15 carbon atoms, 1 to 12 carbon atoms, 1 to 8 carbon atoms, 1 to 6 carbon atoms, or 1 to 4 carbon atoms. In a further aspect, an organic residue can comprise 2 to 18 carbon atoms, 2 to 15, carbon atoms, 2 to 12 carbon atoms, 2 to 8 carbon atoms, 2 to 4 carbon atoms, or 2 to 4 carbon atoms.

A very close synonym of the term “residue” is the term “radical,” which as used in the specification and concluding claims, refers to a fragment, group, or substructure of a molecule described herein, regardless of how the molecule is prepared. For example, a 2,4-thiazolidinedione radical in a particular compound has the structure

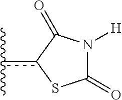

regardless of whether thiazolidinedione is used to prepare the compound. In some embodiments the radical (for example an alkyl) can be further modified (i.e., substituted alkyl) by having bonded thereto one or more “substituent radicals.” The number of atoms in a given radical is not critical to the present invention unless it is indicated to the contrary elsewhere herein.

“Organic radicals,” as the term is defined and used herein, contain one or more carbon atoms. An organic radical can have, for example, 1-26 carbon atoms, 1-18 carbon atoms, 1-12 carbon atoms, 1-8 carbon atoms, 1-6 carbon atoms, or 1-4 carbon atoms. In a further aspect, an organic radical can have 2-26 carbon atoms, 2-18 carbon atoms, 2-12 carbon atoms, 2-8 carbon atoms, 2-6 carbon atoms, or 2-4 carbon atoms. Organic radicals often have hydrogen bound to at least some of the carbon atoms of the organic radical. One example, of an organic radical that comprises no inorganic atoms is a 5, 6, 7, 8-tetrahydro-2-naphthyl radical. In some embodiments, an organic radical can contain 1-10 inorganic heteroatoms bound thereto or therein, including halogens, oxygen, sulfur, nitrogen, phosphorus, and the like. Examples of organic radicals include but are not limited to an alkyl, substituted alkyl, cycloalkyl, substituted cycloalkyl, mono-substituted amino, di-substituted amino, acyloxy, cyano, carboxy, carboalkoxy, alkylcarboxamide, substituted alkylcarboxamide, dialkylcarboxamide, substituted dialkylcarboxamide, alkylsulfonyl, alkylsulfinyl, thioalkyl, thiohaloalkyl, alkoxy, substituted alkoxy, haloalkyl, haloalkoxy, aryl, substituted aryl, heteroaryl, heterocyclic, or substituted heterocyclic radicals, wherein the terms are defined elsewhere herein. A few non-limiting examples of organic radicals that include heteroatoms include alkoxy radicals, trifluoromethoxy radicals, acetoxy radicals, dimethylamino radicals and the like.

“Inorganic radicals,” as the term is defined and used herein, contain no carbon atoms and therefore comprise only atoms other than carbon. Inorganic radicals comprise bonded combinations of atoms selected from hydrogen, nitrogen, oxygen, silicon, phosphorus, sulfur, selenium, and halogens such as fluorine, chlorine, bromine, and iodine, which can be present individually or bonded together in their chemically stable combinations. Inorganic radicals have 10 or fewer, or preferably one to six or one to four inorganic atoms as listed above bonded together. Examples of inorganic radicals include, but not limited to, amino, hydroxy, halogens, nitro, thiol, sulfate, phosphate, and like commonly known inorganic radicals. The inorganic radicals do not have bonded therein the metallic elements of the periodic table (such as the alkali metals, alkaline earth metals, transition metals, lanthanide metals, or actinide metals), although such metal ions can sometimes serve as a pharmaceutically acceptable cation for anionic inorganic radicals such as a sulfate, phosphate, or like anionic inorganic radical. Inorganic radicals do not comprise metalloids elements such as boron, aluminum, gallium, germanium, arsenic, tin, lead, or tellurium, or the noble gas elements, unless otherwise specifically indicated elsewhere herein.

In defining various terms, “A¹,” “A²,” “A³,” and “A⁴” are used herein as generic symbols to represent various specific substituents. These symbols can be any substituent, not limited to those disclosed herein, and when they are defined to be certain substituents in one instance, they can, in another instance, be defined as some other substituents.

The term “alkyl” as used herein is a branched or unbranched saturated hydrocarbon group of 1 to 24 carbon atoms, for example, 1 to 12 carbon atoms, 1 to 9 carbon atoms, 1 to 6 carbon atoms, 1 to 4 carbon atoms. Examples of alkyl include, but are not limited to methyl, ethyl, n propyl, isopropyl, n butyl, isobutyl, t butyl, pentyl, hexyl, heptyl, octyl, decyl, tetradecyl, hexadecyl, eicosyl, tetracosyl and the like. The alkyl group can also be substituted or unsubstituted. The alkyl group can be substituted with one or more groups including, but not limited to, alkyl, halogenated alkyl, alkoxy, alkenyl, alkynyl, aryl, heteroaryl, aldehyde, amino, carboxylic acid, ester, halide, hydroxamate, hydroxy, ketone, nitro, silyl, sulfo-oxo, sulfonyl, sulfone, sulfoxide, or thiol, as described below. The term “halogenated alkyl” specifically refers to an alkyl group that is substituted with one or more halide, e.g., fluorine, chlorine, bromine, or iodine. A “lower alkyl” group is an alkyl group containing from one to six (e.g., from one to four, one to three, or one to two) carbon atoms.

The term “alkoxy” as used herein is an alkyl group bound through a single, terminal ether linkage; that is, an “alkoxy” group can be defined as —OA where A is alkyl as defined above.

The term “alkenyl” as used herein is a hydrocarbon group of from 2 to 24 carbon atoms with a structural formula containing at least one carbon-carbon double bond. Asymmetric structures such as (AB)C═C(CD) are intended to include both the E and Z isomers. This can be presumed in structural formulae herein wherein an asymmetric alkene is present, or it can be explicitly indicated by the bond symbol C═C.

The term “alkynyl” as used herein is a hydrocarbon group of 2 to 24 carbon atoms with a structural formula containing at least one carbon-carbon triple bond, i.e., C≡C.

The term “aryl” as used herein is any carbon-based aromatic group including, but not limited to, benzene, naphthalene, phenyl, biphenyl, etc. The term “aromatic” also includes “heteroaryl,” which is defined as an aromatic group that has at least one heteroatom incorporated within the ring of the aromatic group. Examples of heteroatoms include, but are not limited to, nitrogen, oxygen, sulfur, and phosphorus. The aryl group can be substituted or unsubstituted. The aryl group can be substituted with one or more groups including, but not limited to, alkyl, halogenated alkyl, alkoxy, alkenyl, alkynyl, aryl, heteroaryl, aldehyde, amino, carboxylic acid, ester, halide, hydroxamate, hydroxy, ketone, nitro, silyl, sulfo-oxo, sulfonyl, sulfone, sulfoxide, or thiol as described herein. The term “biaryl” is a specific type of aryl group and is included in the definition of aryl. Biaryl refers to two aryl groups that are bound together via a fused ring structure, as in naphthalene, or are attached via one or more carbon-carbon bonds, as in biphenyl.

The term “cycloalkyl” as used herein is a non-aromatic carbon-based ring composed of at least three carbon atoms. Examples of cycloalkyl groups include, but are not limited to, cyclopropyl, cyclobutyl, cyclopentyl, cyclohexyl, etc. The term “heterocycloalkyl” is a cycloalkyl group as defined above where at least one of the carbon atoms of the ring is substituted with a heteroatom such as, but not limited to, nitrogen, oxygen, sulfur, or phosphorus. The cycloalkyl group and heterocycloalkyl group can be substituted or unsubstituted. The cycloalkyl group and heterocycloalkyl group can be substituted with one or more groups including, but not limited to, alkyl, alkoxy, alkenyl, alkynyl, aryl, heteroaryl, aldehyde, amino, carboxylic acid, ester, halide, hydroxamate, hydroxy, ketone, nitro, silyl, sulfo-oxo, sulfonyl, sulfone, sulfoxide, or thiol as described herein.

The term “cycloalkenyl” as used herein is a non-aromatic carbon-based ring composed of at least three carbon atoms and contains at least one carbon-carbon double bound, C═C. Examples of cycloalkenyl groups include, but are not limited to, cyclopropenyl, cyclobutenyl, cyclopentenyl, cyclopentadienyl, cyclohexenyl, etc. The term “heterocycloalkenyl” is a cycloalkenyl group as defined above where at least one of the carbon atoms of the ring is substituted with a heteroatom such as, but not limited to, nitrogen, oxygen, sulfur, or phosphorus. The cycloalkenyl group and heterocycloalkenyl group can be substituted or unsubstituted. The cycloalkenyl group and heterocycloalkenyl group can be substituted with one or more groups including, but not limited to, alkyl, alkoxy, alkenyl, alkynyl, aryl, heteroaryl, aldehyde, amino, carboxylic acid, ester, halide, hydroxamate, hydroxy, ketone, nitro, silyl, sulfo-oxo, sulfonyl, sulfone, sulfoxide, or thiol as described herein.

The term “aldehyde” as used herein is represented by the formula —C(O)H.

The terms “amine” or “amino” as used herein are represented by the formula -NAA¹A², where A, A¹, and A² can be, independently, any suitable substituent, including hydrogen, alkyl, halogenated alkyl, alkenyl, alkynyl, aryl, heteroaryl, cycloalkyl, cycloalkenyl, heterocycloalkyl, or heteroalkenyl group described above. An amino group can be present as an N-oxide. An “N-oxide,” as used herein is represented by a formula N(O)AA¹A², where A, A¹, and A² are as defined above. An “N-oxide” can comprise a dative bond, i.e., N→O, which is sometimes represented by the formula, N═O.

The term “carboxylic acid” as used herein is represented by the formula —C(O)OH.

The term “ester” as used herein is represented by the formula —C(O)OA, where A can be an alkyl, halogenated alkyl, alkenyl, alkynyl, aryl, heteroaryl, cycloalkyl, cycloalkenyl, heterocycloalkyl, or heterocycloalkenyl group described above.

The term “ether” as used herein is represented by the formula AOA1, where A and A1 can be, independently, an alkyl, halogenated alkyl, alkenyl, alkynyl, aryl, heteroaryl, cycloalkyl, cycloalkenyl, heterocycloalkyl, or heterocycloalkenyl group described above.

The term “ketone” as used herein is represented by the formula —C(O)—.

The term “halide” as used herein refers to the halogens fluorine, chlorine, bromine, and iodine.

The term “hydroxyl” as used herein is represented by the formula —OH.

The term “nitro” as used herein is represented by the formula —NO₂.

The term “thiol” as used herein is represented by the formula —SH.

The term “cyano” as used herein is represented by the formula —CN.

The term “azide” as used herein is represented by the formula —N₃.

The term “peroxide” as used herein is represented by the formula —O—O—.

The terms “methyl propylimidazolium iodide,” “1-methyl-3-propylimidazolium iodide,” or “MPII” as used herein is represented by the formula:

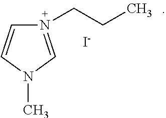

Compounds described herein can contain one or more double bonds and, thus, potentially give rise to cis/trans (E/Z) isomers, as well as other conformational isomers. Unless stated to the contrary, the invention includes all such possible isomers, as well as mixtures of such isomers.

The term “substantially” as used herein can be applied to modify any quantitative representation which could permissibly vary without resulting in a change in the basic function to which it is related. For example, the term “substantially pure” is intended to refer to a mixture wherein the desired compound is present in from about 70% to about 100% parts by weight, e.g., 75%, 80%, 90%, 95%, 99%.

The term “oxidizable functional group” is meant to refer to a functional group capable of undergoing oxidation, e.g., an increase in oxygen content or decrease in hydrogen content.

The term “leaving group” is meant to refer to an atom (or a group of atoms) with electron withdrawing ability that can be displaced as a stable species, taking with it the bonding electrons. Examples of suitable leaving groups include sulfonate esters, including, but not limited to, triflate, mesylate, tosylate, brosylate, and halides.

As used herein, and without limitation, the term “derivative” is used to refer to any compound which has a structure derived from the structure of the compounds disclosed herein and whose structure is sufficiently similar to those disclosed herein and based upon that similarity, would be expected, by one skilled in the art, to exhibit the same or similar activities and utilities as the claimed compounds, or to induce, as a precursor, the same or similar activities and utilities as the claimed compounds. For example, a derivative can be a prodrug, a metabolite, or a pharmaceutically acceptable derivative.

The term “pharmaceutically acceptable” means a material that is not biologically or otherwise undesirable, i.e., without causing any undesirable biological effects or interacting in a deleterious manner.

Disclosed are the components to be used to prepare the compositions as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds cannot be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions. Thus, if there are a variety of additional steps that can be performed it is understood that each of these additional steps can be performed with any specific embodiment or combination of embodiments of the methods.

It is understood that the compositions disclosed herein have certain functions. Disclosed herein are certain structural requirements for performing the disclosed functions, and it is understood that there are a variety of structures that can perform the same function that are related to the disclosed structures, and that these structures will typically achieve the same result.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

### B. FILTRATION APPARATUS

In accordance with the purpose(s) of the invention, as embodied and broadly described herein, the invention, in one aspect, relates to filter apparatuses useful as sampling media. In a further aspect, the disclosed filter apparatuses are useful for capturing airborne particles in the environment, for example, aerosolized pharmaceutical compounds. In a still further aspect, the invention relates to filter apparatuses useful for stabilizing pharmaceutical compounds, methods of making same, compositions useful for stabilizing pharmaceutical compounds, and methods of isolating pharmaceutical compounds from an air stream using the apparatuses and compositions.

In one aspect, the disclosed filter apparatuses capture aerosolized pharmaceutical compounds from the surrounding air environment. In a further aspect, the filter apparatuses stabilize pharmaceutical compounds, for example, aerosolized pharmaceutical compounds captured from the air. In a still further aspect, the filter apparatuses stabilize the aerosolized pharmaceutical compounds to oxidative degradation.

In various aspects, oxidative degradation can arise from reaction of the pharmaceutical compound with molecular oxygen or with oxidizing components present in the environment. In a further aspect, oxidative process generally originates with the formation of a free radical that begins a chain reaction. Free radical formation can occur as result of numerous causes, such as homolytic cleavage of a weak bond by a contaminant or impurity, or environmental-induced reactions. Regardless of the source, free radical formation opens a variety of potential drug oxidation reactions generally resulting in radical chain propagation.

In various aspects, radical chain propagation can take place take place through hydrogen abstraction from the pharmaceutical compound, free radical addition to the pharmaceutical compound, reaction with molecular oxygen to form a peroxyl radical, rearrangement, and cyclization. However, when oxygen is involved, the free radical product will rarely lose an oxygen molecule, and usually signals irreversible drug decomposition.

In other aspects, a by-products of the chain propagation process is a hydroperoxide of the pharmaceutical compound, which itself can act as an oxidant for the pharmaceutical compound. With oxygen present, radical propagation can lead to large turnovers where every step creates a degradation product of the drug.

In some aspects, termination of propagating radicals occurs upon formation of a non-radical product. In one aspect, termination can happen after two radicals form a new bond together after radical combination reactions. In another aspect, termination can occur when one radical is reduced while the other is oxidized, typically involving hydrogen-atom donation from one radical to the other. In the solid state, termination is hampered by the inability of radicals to collide, potentially leading to higher concentrations of radicals than seen in solution.

Disclosed herein are filtration apparatuses comprising at least one ionic liquid iodide compound; and a hydrophilic filter membrane. In a further aspect, the filtration apparatus comprises a composition of an ionic liquid iodide and at least one antioxidant; and a hydrophilic filter membrane.

Also disclosed herein are filtration apparatuses comprising: (a) a composition of an ionic liquid iodide and an antioxidant selected from ascorbic acid (Vitamin C), adipic acid, butylated hydroxyanisole (BHA), butylated hydroxytoluene (BHT), citric acid, fumaric acid, glutamic acid, malic acid, propyl gallate, sulfurous acid, tartaric acid, tocopherol (Vitamin E), thiols, and derivatives and salts thereof; and (b) a hydrophilic filter membrane.

In various aspects, the antioxidant can comprise any compatible antioxidant agent. In a further aspect, the antioxidant agent comprises an agent that does not interact with the pharmaceutical compound. In a still further aspect, the antioxidant comprises a pharmaceutically acceptable antioxidant, for example, an antioxidant that has been designated as “GRAS,” or generally recognized as safe, under sections 201(s) and 409 of the Federal Food, Drug, and Cosmetic Act. In yet further aspect, the term “pharmaceutically acceptable” can mean approved by a regulatory agency of the Federal or a state government or listed in the U.S. Pharmacopeia or other generally recognized pharmacopeia for use in animals, and more particularly in humans.

In a further aspect, the antioxidant comprises a chain terminating antioxidant. In a still further aspect, chain terminating antioxidants comprise molecules containing weakly bonded hydrogen atoms, and making attractive targets in oxidation reactions. Significantly, when these molecules are attacked during the oxidation process, they form stable radicals, and thus, disrupt subsequent oxidation and chain propagation. Non-limiting examples of chain terminating antioxidants include thiols, which dimerize to form disulfides, and phenols, which donate hydrogen atoms and are subsequently oxidized to enones.

In a further aspect, due to their disruptive mechanism of action, chain terminating antioxidants are effective at low concentrations. In a still further aspect, chain terminators are generally stable in air, and are not typically consumed outside of the degradative process.

In a further aspect, the antioxidant comprises a sacrificial reductant antioxidant. In a still further aspect, sacrificial reductant antioxidants comprise compounds that are preferentially oxidized over a pharmaceutical compound. In a yet further aspect, sacrificial reductant antioxidants scavenge oxygen, while they themselves are destroyed upon scavenging. Non-limiting examples of sacrificial reductant antioxidants include ascorbic acid (Vitamin C) and sulfites.

In a further aspect, due to their mechanism of action, sacrificial reductant antioxidants can lower the oxygen level in the immediate environment. In a still further aspect, sacrificial reductant antioxidants are more readily consumed, and can require higher concentrations.

In a further aspect, the concentration of the antioxidant will vary depending on the antioxidant agent. In a still further aspect, the concentration is an amount effect to prevent oxidation of an pharmaceutical compound. In a still further aspect, the antioxidant concentration is at least about 1.0 μg per filter apparatus. In a yet further aspect, the antioxidant concentration is at least about 1.5 μg per filter. In an even further aspect, the antioxidant concentration is in a range of from about 1.0 to about 10 μg per filter apparatus. In a still further aspect, the antioxidant concentration is in a range of from about 1.8 to about 2.2 μg per filter apparatus.

In a further aspect, the antioxidant comprises a combination of antioxidants. In a still further aspect, the combination of antioxidants can exhibit synergistic effects, that is, acting more strongly in combination than independently. In a yet further aspect, the antioxidant is selected from ascorbic acid (Vitamin C), adipic acid, butylated hydroxyanisole (BHA), butylated hydroxytoluene (BHT), citric acid, fumaric acid, glutamic acid, malic acid, propyl gallate, sulfurous acid, tartaric acid, tocopherol (Vitamin E), thiols, and derivatives and salts thereof.

In a further aspect, the antioxidant is ascorbic acid, or a derivative or salt thereof. In a still further aspect, the ascorbic acid, derivative, or salt thereof, is selected from ascorbyl palmitate, Mg ascorbyl phosphate, ascorbyl acetate, sodium ascorbate, ascorbic acid palmitate and erythorbic acid.

In a further aspect, the antioxidant is a thiol, or a derivative, or a salt thereof. In a still further aspect, the thiol, derivative, or salt thereof, is select from thioglycerol, cysteine, acetylcysteine, cystine, dithioerythreitol, dithiothreitol, and gluthathione.

In a further aspect, the antioxidant is sulfurous acid, or a derivative, or a salt thereof. In a still further aspect, the sulfurous acid, derivative, or salt thereof, is selected from sodium sulfate, sodium bisulfite, acetone sodium bisulfite, sodium metabisulfite, sodium sulfite, sodium thiosulfate, sodium formaldehyde sulfoxylate and sodium thiosulfate.

In various further aspects, the disclosed filter apparatuses comprise compositions or compounds for stabilizing pharmaceutical compounds. In one aspect, the filter apparatuses comprise at least one ionic liquid. In a still further aspect, the ionic liquid comprises a room-temperature ionic liquid (RTIL). In a yet further aspect, the ionic liquid comprises an ionic liquid iodine. In an even further aspect, the ionic liquid iodide comprises at least one dialkylimidazolium iodide compound, for example, ionic liquid iodide having 1,3-dialkylimidazolium cations. In a still further aspect, the ionic liquid iodine comprises methyl propylimidazolium iodide (MPII). In a yet further aspect, the ionic liquid iodine is methyl butylimidazolium iodide.

In various aspects, the disclosed filter apparatuses comprise a hydrophilic filter membrane. In a further aspect, the hydrophilic filter membrane comprises a nylon membrane. In a still further aspect, the hydrophilic filter membrane comprises a polyvinylidene difluoride (PVDF) membrane.

It is understood that the disclosed apparatuses can be used in connection with the disclosed methods, compositions, and uses. It is also contemplated that any one or more disclosed compound can be optionally omitted from the invention.

### C. METHODS OF MAKING THE FILTRATION APPARATUS

In one aspect, the invention also relates to methods of making filter apparatuses. In a further aspect, the filter apparatuses are useful in capturing airborne particles present in the environment, for example, aerosolized pharmaceutical compounds. In a still further aspect, the filter apparatuses stabilize captured aerosolized pharmaceutical compounds.

The filtration apparatuses of the present invention can be prepared by employing the steps as shown in the disclosed methods, in addition to other standard manipulations that are known in the literature, exemplified in the experimental sections or clear to one skilled in the art. The following examples are provided so that the invention might be more fully understood, are illustrative only, and should not be construed as limiting.

It is contemplated that each disclosed method can further comprise additional steps, manipulations, and/or components. It is also contemplated that any one or more step, manipulation, and/or component can be optionally omitted from the invention. It is understood that a disclosed method can be used to provide the disclosed compounds. It is also understood that the products of the disclosed methods can be employed in the disclosed compositions, methods, and uses.

Certain materials, compounds, compositions, and components disclosed herein can be obtained commercially or synthesized using techniques generally known to those of skill in the art or by methods disclosed herein. For example, the starting materials and reagents used in preparing the disclosed compounds and compositions are either available from commercial suppliers such as Aldrich Chemical Co., (Milwaukee, Wis.), Acros Organics (Morris Plains, N.J.), Fisher Scientific (Pittsburgh, Pa.), or Sigma (St. Louis, Mo.) or are prepared by methods known to those skilled in the art following procedures set forth in references such as Fieser and Fieser's Reagents for Organic Synthesis, Volumes 1-17 (John Wiley and Sons, 1991); Rodd's Chemistry of Carbon Compounds, Volumes 1-5 and Supplementals (Elsevier Science Publishers, 1989); Organic Reactions, Volumes 1-40 (John Wiley and Sons, 1991); March's Advanced Organic Chemistry, (John Wiley and Sons, 4th Edition); and Larock's Comprehensive Organic Transformations (VCH Publishers Inc., 1989).

Disclosed herein is a method of making filtration apparatus, the method comprising the steps of: (a) mixing a low boiling solvent, an ionic liquid iodide, and an antioxidant; (b) applying the mixture to a hydrophilic filter membrane; and (c) forming a gel from the mixture on the membrane by removing at least a portion of the solvent.

Also disclosed herein is a method of making filtration apparatus, the method comprising the steps of: (a) mixing a low boiling solvent, an ionic liquid iodide, and an antioxidant selected from ascorbic acid (Vitamin C), adipic acid, butylated hydroxyanisole (BHA), butylated hydroxytoluene (BHT), citric acid, fumaric acid, glutamic acid, malic acid, propyl gallate, sulfurous acid, tartaric acid, tocopherol (Vitamin E), thiols, and derivatives and salts thereof; (b) applying the mixture to a hydrophilic filter membrane; and (c) forming a gel from the mixture on the membrane by removing at least a portion of the solvent.

In one aspect, the method comprises at least one ionic liquid iodide compound; and a hydrophilic filter membrane. In a further aspect, the filtration apparatus comprises a composition of an ionic liquid iodide and at least one antioxidant; and a hydrophilic filter membrane.

In various aspects, the methods comprise using at least one antioxidant. In one aspect, the antioxidant can comprise any compatible antioxidant agent. In a further aspect, the antioxidant agent comprises an agent that does not interact with the pharmaceutical compound. In a still further aspect, the antioxidant comprises a pharmaceutically acceptable antioxidant, for example, an antioxidant that has been designated as “GRAS,” or generally recognized as safe, under sections 201(s) and 409 of the Federal Food, Drug, and Cosmetic Act. In yet further aspect, the term “pharmaceutically acceptable” can mean approved by a regulatory agency of the Federal or a state government or listed in the U.S. Pharmacopeia or other generally recognized pharmacopeia for use in animals, and more particularly in humans.

In a further aspect, the antioxidant comprises a chain terminating antioxidant. In a still further aspect, chain terminating antioxidants comprise molecules containing weakly bonded hydrogen atoms, and making attractive targets in oxidation reactions. Significantly, when these molecules are attacked during the oxidation process, they form stable radicals, and thus, disrupt subsequent oxidation and chain propagation. Non-limiting examples of chain terminating antioxidants include thiols, which dimerize to form disulfides, and phenols, which donate hydrogen atoms and subsequently oxidized to enones.

In a further aspect, the antioxidant comprises a sacrificial reductant antioxidant. In a still further aspect, sacrificial reductant antioxidants comprise compounds that are preferentially oxidized over a pharmaceutical compound. In a yet further aspect, sacrificial reductant antioxidants scavenge oxygen, while they themselves are destroyed upon scavenging. Non-limiting examples of sacrificial reductant antioxidants include ascorbic acid (Vitamin C) and sulfites.

In a further aspect, the antioxidant comprises a combination of antioxidants. In a still further aspect, the combination of antioxidants can exhibit synergistic effects, that is, acting more strongly in combination than independently. In a yet further aspect, the antioxidant is selected from ascorbic acid (Vitamin C), adipic acid, butylated hydroxyanisole (BHA), butylated hydroxytoluene (BHT), citric acid, fumaric acid, glutamic acid, malic acid, propyl gallate, sulfurous acid, tartaric acid, tocopherol (Vitamin E), thiols, and derivatives and salts thereof.

In a further aspect, the antioxidant is ascorbic acid, or a derivative or salt thereof. In a still further aspect, the ascorbic acid, derivative, or salt thereof, is selected from ascorbyl palmitate, Mg ascorbyl phosphate, ascorbyl acetate, sodium ascorbate, ascorbic acid palmitate and erythorbic acid.

In a further aspect, the antioxidant is a thiol, or a derivative, or a salt thereof. In a still further aspect, the thiol, derivative, or salt thereof, is select from thioglycerol, cysteine, acetylcysteine, cystine, dithioerythreitol, dithiothreitol, and gluthathione.

In a further aspect, the antioxidant is sulfurous acid, or a derivative, or a salt thereof. In a still further aspect, the sulfurous acid, derivative, or salt thereof, is selected from sodium sulfate, sodium bisulfite, acetone sodium bisulfite, sodium metabisulfite, sodium sulfite, sodium thiosulfate, sodium formaldehyde sulfoxylate and sodium thiosulfate.

In a further aspect, the concentration of the antioxidant will vary depending on the antioxidant agent. In a still further aspect, the concentration is an amount effect to prevent oxidation of an pharmaceutical compound. In a still further aspect, the antioxidant concentration is at least about 1.0 μg per filter apparatus. In a yet further aspect, the antioxidant concentration is at least about 1.5 μg per filter. In an even further aspect, the antioxidant concentration is in a range of from about 1.0 to about 10 μg per filter apparatus. In a still further aspect, the antioxidant concentration is in a range of from about 1.8 to about 2.2 μg per filter apparatus

In various further aspects, the methods for making the disclosed filter apparatuses comprise compositions or compounds for stabilizing pharmaceutical compounds. In one aspect, the filter apparatuses comprise at least one ionic liquid. In a still further aspect, the ionic liquid comprises a room-temperature ionic liquids (RTIL). In a yet further aspect, the ionic liquid comprises an ionic liquid iodine. In an even further aspect, the ionic liquid iodide comprises at least one dialkylimidazolium iodide compound, for example, ionic liquid iodide having 1,3-dialkylimidazolium cations. In a still further aspect, the ionic liquid iodine comprises methyl propylimidazolium iodide (MPII). In a yet further aspect, the ionic liquid iodine is methyl butylimidazolium iodide.

In various aspects, the methods for making filter apparatuses comprise a hydrophilic filter membrane. In a further aspect, the hydrophilic filter membrane comprises a nylon membrane. In a still further aspect, the hydrophilic filter membrane comprises a polyvinylidene difluoride (PVDF) membrane.

In a further aspect, the methods for making the filter apparatuses comprise a solvent. In one aspect, the solvent is a low boiling solvent. In a further aspect, the solvent is a low boiling, polar solvent. In a still further aspect, the solvent is selected from methanol, ethanol, acetonitrile, and water.

In a further aspect, the methods for making the filter apparatuses comprise mixing the low boiling solvent, ionic liquid iodide, and antioxidant. In a further aspect, the low boiling solvent, ionic liquid iodide, and antioxidant are intimately admixed to make a uniform mixture.

In a further aspect, the methods for making the filter apparatuses comprise applying the mixture to a hydrophilic filter membrane. In a further aspect, the mixture can be deposited on the membrane. In a still further aspect, the filter membrane can be immersed in the mixture.

In a further aspect, the methods for making the filter apparatuses comprise forming a gel from the mixture on the membrane. In a still further aspect, the gel is formed by removing at least a portion of the solvent. In a yet further aspect, the solvent can be removed by any suitable means, for example, by evaporation or drying.

In various aspects, the resulting gel substrate assists the filter apparatuses in stabilizing any captured pharmaceutical aerosols to oxidative degradation. In a further aspect, the gel substrate traps, dissolves, and protects the captured pharmaceutical aerosols from further oxidative degradation. In a still further aspects, the presence of the antioxidant is believed to further enhance the protective and stabilizing aspects of the disclosed filter membranes.

Also disclosed herein is the product of any disclosed methods.

It should also be understood that the methods disclosed herein can be used in connection with the compositions, uses and methods disclosed herein.

### D. METHODS OF ISOLATING PHARMACEUTICAL COMPOUNDS

In other aspects, the invention also relates to methods of isolating pharmaceutical compounds from an air stream. In a further aspect, the methods of isolating pharmaceutical compounds use the disclosed apparatuses, methods, and compositions.

Disclosed are methods of isolating pharmaceutical compounds from an air stream, the method comprising the steps of: (a) providing a disclosed apparatus or a product produced by a disclosed process; and (b) exposing the apparatus or product to the air stream for a period of time sufficient to capture at least a portion of the pharmaceutical compounds.

Also disclosed are methods of isolating pharmaceutical compounds from an air stream, the method comprising the steps of: (a) providing a disclosed apparatus or a product produced by a disclosed process; (b) exposing the apparatus or product to the air stream for a period of time sufficient to capture at least a portion of the pharmaceutical compounds; (c) extracting the captured pharmaceutical compounds from the apparatus or product; and (d) detecting the extracted pharmaceutical compounds.

In various aspects, the methods of isolating pharmaceutical compounds comprise providing a disclosed filter apparatuses. In other aspects, the methods of isolating pharmaceutical compounds comprise providing a filter apparatus produced by a disclosed method.

In various aspects, the methods of isolating pharmaceutical compounds from an air stream comprise using at least one antioxidant. In one aspect, the antioxidant can comprise any compatible antioxidant agent. In a further aspect, the antioxidant agent comprises an agent that does not interact with the pharmaceutical compound. In a still further aspect, the antioxidant comprises a pharmaceutically acceptable antioxidant, for example, an antioxidant that has been designated as “GRAS,” or generally recognized as safe, under sections 201(s) and 409 of the Federal Food, Drug, and Cosmetic Act. In yet further aspect, the term “pharmaceutically acceptable” can mean approved by a regulatory agency of the Federal or a state government or listed in the U.S. Pharmacopeia or other generally recognized pharmacopeia for use in animals, and more particularly in humans.

In a further aspect, the antioxidant comprises a chain terminating antioxidant. In a still further aspect, chain terminating antioxidants comprise molecules containing weakly bonded hydrogen atoms, and making attractive targets in oxidation reactions. Significantly, when these molecules are attacked during the oxidation process, they form stable radicals, and thus, disrupt subsequent oxidation and chain propagation. Non-limiting examples of chain terminating antioxidants include thiols, which dimerize to form disulfides, and phenols, which donate hydrogen atoms and subsequently oxidized to enones.

In a further aspect, the antioxidant comprises a sacrificial reductant antioxidant. In a still further aspect, sacrificial reductant antioxidants comprise compounds that are preferentially oxidized over a pharmaceutical compound. In a yet further aspect, sacrificial reductant antioxidants scavenge oxygen, while they themselves are destroyed upon scavenging. Non-limiting examples of sacrificial reductant antioxidants include ascorbic acid (Vitamin C) and sulfites.

In a further aspect, the antioxidant comprises a combination of antioxidants. In a still further aspect, the combination of antioxidants can exhibit synergistic effects, that is, acting more strongly in combination than independently. In a yet further aspect, the antioxidant is selected from ascorbic acid (Vitamin C), adipic acid, butylated hydroxyanisole (BHA), butylated hydroxytoluene (BHT), citric acid, fumaric acid, glutamic acid, malic acid, propyl gallate, sulfurous acid, tartaric acid, tocopherol (Vitamin E), thiols, and derivatives and salts thereof.

In a further aspect, the antioxidant is ascorbic acid, or a derivative or salt thereof. In a still further aspect, the ascorbic acid, derivative, or salt thereof, is selected from ascorbyl palmitate, Mg ascorbyl phosphate, ascorbyl acetate, sodium ascorbate, ascorbic acid palmitate and erythorbic acid.

In a further aspect, the antioxidant is a thiol, or a derivative, or a salt thereof. In a still further aspect, the thiol, derivative, or salt thereof, is select from thioglycerol, cysteine, acetylcysteine, cystine, dithioerythreitol, dithiothreitol, and gluthathione.

In a further aspect, the antioxidant is sulfurous acid, or a derivative, or a salt thereof. In a still further aspect, the sulfurous acid, derivative, or salt thereof, is selected from sodium sulfate, sodium bisulfite, acetone sodium bisulfite, sodium metabisulfite, sodium sulfite, sodium thiosulfate, sodium formaldehyde sulfoxylate and sodium thiosulfate.

In a further aspect, the concentration of the antioxidant will vary depending on the antioxidant agent. In a still further aspect, the concentration is an amount effect to prevent oxidation of an pharmaceutical compound. In a still further aspect, the antioxidant concentration is at least about 1.0 μg per filter apparatus. In a yet further aspect, the antioxidant concentration is at least about 1.5 μg per filter. In an even further aspect, the antioxidant concentration is in a range of from about 1.0 to about 10 μg per filter apparatus. In a still further aspect, the antioxidant concentration is in a range of from about 1.8 to about 2.2 μg per filter apparatus.

In various further aspects, the methods of isolating pharmaceutical compounds from an air stream involve filter apparatuses employing compositions or compounds for stabilizing pharmaceutical compounds. In one aspect, the filter apparatuses comprise at least one ionic liquid. In a still further aspect, the ionic liquid comprises a room-temperature ionic liquids (RTIL). In a yet further aspect, the ionic liquid comprises an ionic liquid iodine. In an even further aspect, the ionic liquid iodide comprises at least one dialkylimidazolium iodide compound, for example, ionic liquid iodide having 1,3-dialkylimidazolium cations. In a still further aspect, the ionic liquid iodine comprises methyl propylimidazolium iodide (MPII). In a yet further aspect, the ionic liquid iodine is methyl butylimidazolium iodide.

In various aspects, the methods of isolating pharmaceutical compounds from an air stream involve providing filter apparatuses comprising a hydrophilic filter membrane. In a further aspect, the hydrophilic filter membrane comprises a nylon membrane. In a still further aspect, the hydrophilic filter membrane comprises a polyvinylidene difluoride (PVDF) membrane.

In various aspects, disclosed methods of isolating pharmaceutical compounds from an air stream are useful for air sampling. In a further aspect, the methods involve capturing airborne particles present in the air, for example, aerosolized pharmaceutical compounds. In a still further aspect, the methods stabilize captured aerosolized pharmaceutical compounds. In a still further aspect, the stabilized pharmaceutical compounds can then be extracted from the filter apparatus or product.

In a further aspect, the captured pharmaceutical compounds can be extracting from the apparatus or product using any suitable means. In one aspect, the pharmaceutical compound can be extracted using a solvent, for example, a low boiling polar solvent or mixture thereof capable of dissolving the pharmaceutical compound of interest, the ionic liquid iodide, and antioxidant. In a still further aspect, the filter apparatus is immersed low boiling polar solvent or mixture thereof capable of dissolving the pharmaceutical compound of interest, the MPII, and the ascorbic acid. In a yet further aspect, the extraction method can further comprise sonication, agitation, or vortexing to aid in dissolution.

In various aspects, the methods also comprise detecting the extracted pharmaceutical compounds. In a further aspect, the extracted pharmaceutical compounds can be detected by any suitable analytical means. For example, in further aspects, filter apparatus and its contents can be analyzed by any suitable chromatographic separation technique. In a still further aspect, the detection methods further comprise any analytical methods using ultraviolet, fluorescence, mass spectrometric, conductivity, electrochemical, or refractive index detection.

In various aspects, mechanisms of oxidation of pharmaceutical compounds can include direct and catalyzed electron-transfer processes. In other aspects, light can also cause oxidation reactions by inducing cleavage of a bond to form radicals, which, in some aspects, can initiate radical chain propagation.

In some aspects, oxidation by electron transfer occurs to produce the radical cation of the pharmaceutical compound, which, in further aspects, subsequently undergoes additional decomposition. In a further aspect, the radical formed should be relatively stable and the donor have a low electron affinity. In a yet further aspect, amines, thiols, and phenolate ions are especially susceptible to this type of electron transfer. In one aspect, primary and secondary amines can oxidize to hydroxylamines or imines. In another aspect, tertiary amines can oxidize to amine-N-oxides.

In various aspects, the isolated pharmaceutical compounds comprise at least one oxidizable functional group. In a further aspect, the pharmaceutical compounds comprise at least one amine. In still further aspect, the at least one amine comprises a primary or secondary amine. In a yet further aspect, the at least one amine comprises a tertiary amine. In an even further aspect, the pharmaceutical compounds comprise at least one alkene.

### E. COMPOSITIONS FOR STABILIZING PHARMACEUTICAL COMPOUNDS

In other aspects, the invention relates to compositions useful for stabilizing pharmaceutical compounds. In further aspects, the compositions stabilize pharmaceutical compositions from oxidative degradation.

Disclosed herein is a composition comprising a gel formed from an ionic liquid iodide and at least one an antioxidant.

Also disclosed herein is a composition comprising a gel formed from methyl propylimidazolium iodide (MPII) and an antioxidant selected from ascorbic acid (Vitamin C), adipic acid, butylated hydroxyanisole (BHA), butylated hydroxytoluene (BHT), citric acid, fumaric acid, glutamic acid, malic acid, propyl gallate, sulfurous acid, tartaric acid, tocopherol (Vitamin E), thiols, and derivatives and salts thereof.

In various aspects, the gel composition assists in stabilizing captured pharmaceutical aerosols to oxidative degradation. In a further aspect, the gel composition traps, dissolves, and protects the captured pharmaceutical aerosols from further oxidative degradation. In a still further aspects, the presence of the antioxidant is believed to further enhance the protective and stabilizing aspects of the disclosed gel compositions.

In various aspects, the gel composition comprises at least one antioxidant. In one aspect, the antioxidant can comprise any compatible antioxidant agent. In a further aspect, the antioxidant agent comprises an agent that does not interact with the pharmaceutical compound. In a still further aspect, the antioxidant comprises a pharmaceutically acceptable antioxidant, for example, an antioxidant that has been designated as “GRAS,” or generally recognized as safe, under sections 201(s) and 409 of the Federal Food, Drug, and Cosmetic Act. In yet further aspect, the term “pharmaceutically acceptable” can mean approved by a regulatory agency of the Federal or a state government or listed in the U.S. Pharmacopeia or other generally recognized pharmacopeia for use in animals, and more particularly in humans.

In a further aspect, the antioxidant comprises a chain terminating antioxidant. In a still further aspect, chain terminating antioxidants comprise molecules containing weakly bonded hydrogen atoms, and making attractive targets in oxidation reactions. Significantly, when these molecules are attacked during the oxidation process, they form stable radicals, and thus, disrupt subsequent oxidation and chain propagation. Non-limiting examples of chain terminating antioxidants include thiols, which dimerize to form disulfides, and phenols, which donate hydrogen atoms and subsequently oxidized to enones.

In a further aspect, the antioxidant comprises a sacrificial reductant antioxidant. In a still further aspect, sacrificial reductant antioxidants comprise compounds that are preferentially oxidized over a pharmaceutical compound. In a yet further aspect, sacrificial reductant antioxidants scavenge oxygen, while they themselves are destroyed upon scavenging. Non-limiting examples of sacrificial reductant antioxidants include ascorbic acid (Vitamin C) and sulfites.

In a further aspect, the antioxidant comprises a combination of antioxidants. In a still further aspect, the combination of antioxidants can exhibit synergistic effects, that is, acting more strongly in combination than independently. In a yet further aspect, the antioxidant is selected from ascorbic acid (Vitamin C), adipic acid, butylated hydroxyanisole (BHA), butylated hydroxytoluene (BHT), citric acid, fumaric acid, glutamic acid, malic acid, propyl gallate, sulfurous acid, tartaric acid, tocopherol (Vitamin E), thiols, and derivatives and salts thereof.

In a further aspect, the antioxidant is ascorbic acid, or a derivative or salt thereof. In a still further aspect, the ascorbic acid, derivative, or salt thereof, is selected from ascorbyl palmitate, Mg ascorbyl phosphate, ascorbyl acetate, sodium ascorbate, ascorbic acid palmitate and erythorbic acid.

In a further aspect, the antioxidant is a thiol, or a derivative, or a salt thereof. In a still further aspect, the thiol, derivative, or salt thereof, is select from thioglycerol, cysteine, acetylcysteine, cystine, dithioerythreitol, dithiothreitol, and gluthathione.

In a further aspect, the antioxidant is sulfurous acid, or a derivative, or a salt thereof. In a still further aspect, the sulfurous acid, derivative, or salt thereof, is selected from sodium sulfate, sodium bisulfite, acetone sodium bisulfite, sodium metabisulfite, sodium sulfite, sodium thiosulfate, sodium formaldehyde sulfoxylate and sodium thiosulfate.

In a further aspect, the concentration of the antioxidant will vary depending on the antioxidant agent. In a still further aspect, the concentration is an amount effect to prevent oxidation of an pharmaceutical compound. In a still further aspect, the antioxidant concentration is at least about 1.0 μg per filter apparatus. In a yet further aspect, the antioxidant concentration is at least about 1.5 μg per filter. In an even further aspect, the antioxidant concentration is in a range of from about 1.0 to about 10 μg per filter apparatus. In a still further aspect, the antioxidant concentration is in a range of from about 1.8 to about 2.2 μg per filter apparatus.

In various further aspects, the compositions for stabilizing pharmaceutical compounds comprise a gel composition. In one aspect, the compositions comprise a gel formed from at least one ionic liquid. In a still further aspect, the ionic liquid comprises a room-temperature ionic liquids (RTIL). In a yet further aspect, the ionic liquid comprises an ionic liquid iodine. In an even further aspect, the ionic liquid iodide comprises at least one dialkylimidazolium iodide compound, for example, ionic liquid iodide having 1,3-dialkylimidazolium cations. In a still further aspect, the ionic liquid iodine comprises methyl propylimidazolium iodide (MPII). In a yet further aspect, the ionic liquid iodine is methyl butylimidazolium iodide.

In a further aspect, the compositions comprise at least one additional additive. In a still further aspect, the additive can comprise a polymeric material.

### F. USES OF THE FILTER APPARATUSES AND COMPOSITIONS

In various aspects, the disclosed apparatuses, methods, and compositions are also useful in industrial hygiene applications, toxicology applications, quality assurance applications, and engineering specification applications.

In a further aspect, the disclosure relates to kits comprising at least one disclosed filter apparatus or composition and one or more other components, which are usually used in conjunction with assessing industrial hygiene, toxicology, quality assurance, and engineering specifications.

In one aspect, the disclosed kits can comprise one or more of a disclosed filter apparatus, and a means for collecting an air sample. In further aspect. the disclosed kits can comprise one or more of a disclosed composition, and sampling media for coating with a disclosed composition. In a still further aspect, the disclosed kits comprise: (a) a composition of an ionic liquid iodide, (b) a low boiling solvent, and (c) optionally, an antioxidant selected from ascorbic acid (Vitamin C), adipic acid, butylated hydroxyanisole (BHA), butylated hydroxytoluene (BHT), citric acid, fumaric acid, glutamic acid, malic acid, propyl gallate, sulfurous acid, tartaric acid, tocopherol (Vitamin E), thiols, and derivatives and salts thereof. In a yet further aspect, the disclosed kits can comprise: (a) a composition of an ionic liquid iodide, (b) an antioxidant selected from ascorbic acid (Vitamin C), adipic acid, butylated hydroxyanisole (BHA), butylated hydroxytoluene (BHT), citric acid, fumaric acid, glutamic acid, malic acid, propyl gallate, sulfurous acid, tartaric acid, tocopherol (Vitamin E), thiols, and derivatives and salts thereof, and (c) optionally, a low boiling solvent. The kits can be co-packaged, and/or co-delivered with the means for collecting a sample. For example, an equipment manufacturer, a pharmaceutical manufacturer, a laboratory, or an engineer can provide a disclosed kit for delivery.

In a further aspect, the disclosed apparatuses, methods, and compositions also relate to systems comprising at least one disclosed filter apparatus or composition and one or more other components, which are used for testing industrial hygiene, toxicology, quality assurance, and engineering specifications. In a still further aspect, the disclosed filter apparatuses and compositions can comprise sampling media for use in a disclosed system. For example, the disclosed systems can comprise one or more of a disclosed filter apparatus, a means for moving air, and a means for conducting air through the filter apparatus. In some aspects, a means for moving air comprises a sampling pump. In further aspects, a means for conducting air comprises tubing connected to the pump. In a still further aspect, the system can comprise a means for holding a filter apparatus, for example, a filter holder or sampling cassette.

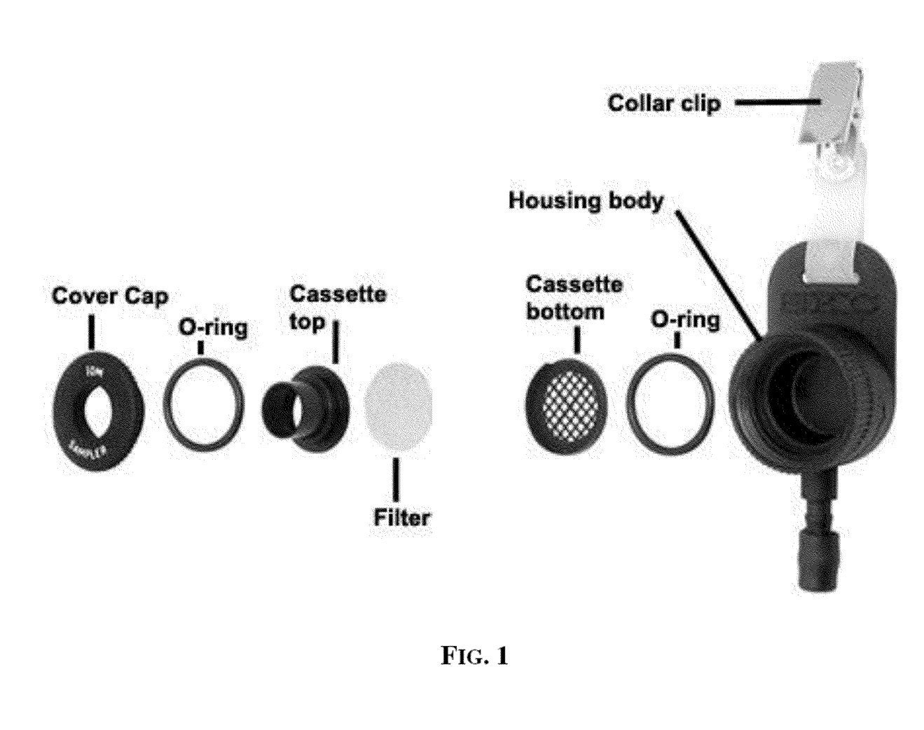

In one aspect, FIG. 1 shows an exemplary filter holder comprising a filter for collection of air samples. In a further aspect, the filter is a disclosed filter apparatus and is used to collect aerosolized pharmaceutical compounds from the air. In a still further aspect, the filter holder is connected to a sampling pump and tubing to conduct the desired volume of air through the filter.

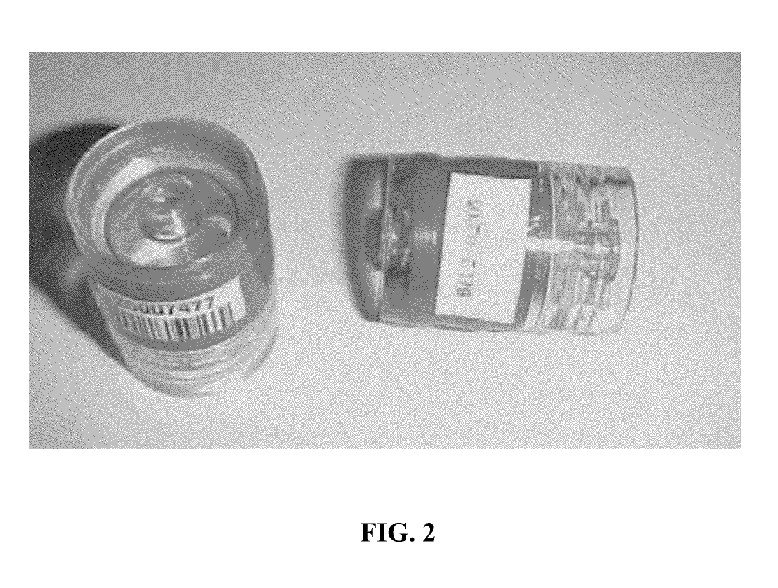

In another aspect, FIG. 2 shows an exemplary sampling cassette containing a filter for collection of air sample. In a further aspect, the filter is a disclosed filter apparatus and is used to collect aerosolized pharmaceutical compounds from the air. In a still further aspect, the sampling cassette is connected to a sampling pump and tubing to conduct the desired volume of air through the filter.

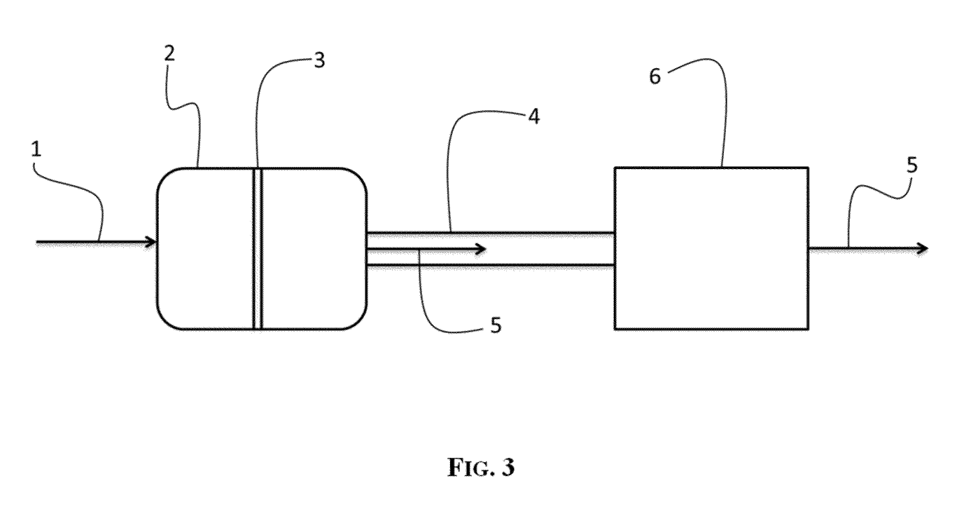

In another aspect, FIG. 3 shows a schematic diagram of a system for air sampling and monitoring in accordance with the present invention. In a further aspect, the system comprises a filter adapter 2 containing a disclosed filter apparatus 3, tubing 4 for conducting air, and a sampling pump 6 for moving air. In a still further aspect, unfiltered air stream 1 comprising aerosolized pharmaceutical compounds is introduced through the filter adapter 2 containing the disclosed filter apparatus 3, wherein the aerosolized pharmaceutical compounds are captured by the disclosed filter apparatus 3. The filtered air stream 5 is continually discharged through the pump until a sufficient volume of air has been collected.

In further aspects, the disclosed apparatuses, methods, and compositions can be used in analytical methods for testing industrial hygiene, toxicology, quality assurance, and engineering specifications. In a still further aspect, the analytical methods comprise off-line monitoring, for example, where samples are collected for subsequent analysis. In a yet further aspect, the analytical methods comprise on-line monitoring, for example, real-time aerosol monitoring.

In further aspects, the disclosure also relates to methods for analyzing pharmaceutical compounds isolated from an air stream, and reports generated using the methods. In a still further aspect, the method comprises the steps of: (a) providing a disclosed apparatus or a product of a disclosed process; (b) exposing the apparatus or product to the air stream for a period of time sufficient to capture at least a portion of the pharmaceutical compounds; (c) extracting the captured pharmaceutical compounds from the apparatus or product; and (d) analyzing the extracted pharmaceutical compounds. In some aspects, detecting comprises identifying. In a further aspect, detecting comprises quantitating. In a still further aspect, the method can further comprise generating a report of the analysis. In a yet further aspect, also disclosed are reports generated using a disclosed method for analysis.

In some aspects, the disclosed apparatuses, methods, and compositions are used to collect samples in testing or manufacturing facilities. In a further aspect, the samples comprise long-term samples, for example, during the entire duration of operation. In a still further aspect, the samples comprise short-term samples, for example, during individual steps or tasks of operation.

In various further aspects, the disclosed apparatuses, methods, and compositions are used to test performance of equipment used in a facility. In a further aspect, the equipment comprises containment equipment used for minimizing discharge of particles into environment. In a still further aspect, containment equipment comprises isolators, transfer systems, and other contained process equipment, including, but not limited to airlock chambers, transfer ports, glove ports, sampling ports, bag-out ports, and dust collection systems.

To verify performance of containment equipment, air samples are regularly taken to determine the airborne particulate concentration. In a further aspect, the samples comprise background air samples in a room or enclosure, breathing zone samples, and general area (static) samples. In a still further aspect, samples can comprise those collected near points of potential leakage.

### G. EXAMPLES

The following examples are put forth so as to provide those of ordinary skill in the art with a complete disclosure and description of how the compounds, compositions, articles, devices and/or methods claimed herein are made and evaluated, and are intended to be purely exemplary and are not intended to limit the disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

General Methods

To address drawbacks in the prior art, a filter apparatus was designed for pharmaceutical aerosol collection and stabilization which prevents oxidative degradation of captured pharmaceutical aerosols. The filter apparatus consists of sampling media coated with a gel substrate to trap, dissolve, and protect captured pharmaceutical aerosols. In various aspects, the sampling media comprises a hydrophilic membrane, and the gel substrate comprises a ionic liquid iodide, and optionally, at least one antioxidant. After collection of air samples, the stabilized pharmaceutical aerosols captured on the sampling media are sent to laboratory for analysis using high-performance liquid chromatography/ultraviolet detection or liquid chromatography—mass spectrometry or tandem mass spectrometry. Briefly, preparation of the membrane filters comprises a quick immersion in a solution comprising the ionic liquid iodide, the at least one antioxidant, and a suitable polar solvent. Following evaporation of the solvent, the membrane filter is ready for sampling.

Pvdf Membrane Filter Preparation

A coating mixture was prepared using MPII, AA, and methanol. The mixture was prepared by dissolving 0.18 gm of MPII and 0.034 gm of AA per ml of methanol. The solution was then placed in a petri dish and 25 mm, 5.0 μm pore size PVDF membrane filters were immersed in the solution for approximately 5-10 seconds. The filters were then removed and excess solution shaken from the filters. The remaining solvent was then allowed to evaporate, leaving a thin coating of MPII and AA on the PVDF filter. The filters are then ready for sampling use to collect pharmaceutical aerosols.

Prophetic Sample Collection:

In various aspects, air sample collection will involve an air moving device, an air conducting device, a medium holder, and sampling media. In this aspect, the filters will be used in conjunction with a filter holder or adapter, such as a sampling cassette, a sampling pump, and attached tubing to capture airborne particles during sample collection. For example, in one aspect, the sampling rate for these filters can be 2 liters per minute for a period in the range of about 15 minutes to about 8 hours.

Prophetic Sample Analysis:

Following sample collection, the filters can be extracted in-cassette or removed and placed in a test tube for extraction. If in-cassette extraction is to be used, 2-5 mL of a suitable low-boiling polar solvent or combination of solvents is delivered to the cassette and the cassette is then gently shaken for approximately 30 minutes. The solution is removed with a glass pipet for analysis. If extracted in a test tube, the same procedure is applied, however vortexing or sonication may be used to aid in dissolution. The filter and contents can be analyzed by any suitable chromatographic separation technique coupled to ultraviolet, fluorescence, mass spectrometric, conductivity, electrochemical, or refractive index detection. In a further aspect, the analytical technique is capable of separating all extractables (MPII, AA, filter and cassettes extractables) from the compound of interest. In a still further aspect, the detection method is able to exclude interferences, for example, those that may co-elute with the compound of interest, i.e., by mass or spectral differences.

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A filtration apparatus comprising:
(a) a composition of an ionic liquid iodide and an antioxidant selected from ascorbic acid (Vitamin C), adipic acid, butylated hydroxyanisole (BHA), butylated hydroxytoluene (BHT), citric acid, fumaric acid, glutamic acid, malic acid, propyl gallate, sulfurous acid, tartaric acid, tocopherol (Vitamin E), thiols, and derivatives and salts thereof; and
(b) a hydrophilic filter membrane.

2. The apparatus of claim 1, wherein the ionic liquid iodine comprises at least one dialkylimidazolium iodide compound.

3. The apparatus of claim 1, wherein the ionic liquid iodine comprises methyl propylimidazolium iodide (MPII).

4. The apparatus of claim 1, wherein the antioxidant is ascorbic acid, or a derivative or salt thereof.

5. The apparatus of claim 1, wherein the ascorbic acid, derivative, or salt thereof, is selected from ascorbyl palmitate, Mg ascorbyl phosphate, ascorbyl acetate, sodium ascorbate, ascorbic acid palmitate and erythorbic acid.

6. The apparatus of claim 1, wherein the thiol, derivative, or salt thereof, is select from thioglycerol, cysteine, acetylcysteine, cystine, dithioerythreitol, dithiothreitol, and gluthathione.

7. The apparatus of claim 1, wherein the sulfurous acid, derivative, or salt thereof, is selected from sodium sulfate, sodium bisulfite, acetone sodium bisulfite, sodium metabisulfite, sodium sulfite, sodium thiosulfate, sodium formaldehyde sulfoxylate and sodium thiosulfate.

8. The apparatus of claim 1, wherein the hydrophilic filter membrane comprises a nylon membrane.

9. The apparatus of claim 1, wherein the hydrophilic filter membrane comprises a polyvinylidene difluoride (PVDF) membrane.

10. A process for making a filtration apparatus, the method comprising the steps of:
(a) mixing a low boiling solvent, an ionic liquid iodide, and an antioxidant selected from ascorbic acid (Vitamin C), adipic acid, butylated hydroxyanisole (BHA), butylated hydroxytoluene (BHT), citric acid, fumaric acid, glutamic acid, malic acid, propyl gallate, sulfurous acid, tartaric acid, tocopherol (Vitamin E), thiols, and derivatives and salts thereof;
(b) applying the mixture to a hydrophilic filter membrane; and
(c) forming a gel from the mixture on the membrane by removing at least a portion of the solvent.

11. The process of claim 10, wherein the ionic liquid iodine comprises at least one dialkylimidazolium iodide compound.

12. The process of claim 10, wherein the ionic liquid iodide comprises methyl propylimidazolium iodide (MPII).

13. The process of claim 10, wherein the antioxidant is ascorbic acid, or a derivative or salt thereof.

14. The process of claim 10, wherein the hydrophilic filter membrane comprises a nylon membrane.

15. The process of claim 10, wherein the hydrophilic filter membrane comprises a polyvinylidene difluoride (PVDF) membrane.

16. The process of claim 10, wherein the low boiling point solvent is selected from methanol, ethanol, and water.

17. A composition comprising a gel formed from methyl propylimidazolium iodide (MPII) and an antioxidant selected from ascorbic acid (Vitamin C), adipic acid, butylated hydroxyanisole (BHA), butylated hydroxytoluene (BHT), citric acid, fumaric acid, glutamic acid, malic acid, propyl gallate, sulfurous acid, tartaric acid, tocopherol (Vitamin E), thiols, and derivatives and salts thereof.

18. The composition of claim 17, wherein the antioxidant is ascorbic acid, or a derivative or salt thereof.

19. The composition of claim 17, wherein the ascorbic acid, derivative, or salt thereof, is selected from ascorbyl palmitate, Mg ascorbyl phosphate, ascorbyl acetate, sodium ascorbate, ascorbic acid palmitate and erythorbic acid.

20. The composition of claim 17, wherein the thiol, derivative, or salt thereof, is select from thioglycerol, cysteine, acetylcysteine, cystine, dithioerythreitol, dithiothreitol, and gluthathione.
